(19) United States
(12) Patent Application Publication
(10) Pub. No.: US 2025/0001898 A1
(43) Pub. Date: Jan. 2, 2025

(54) METHOD FOR INSPECTING VEHICLES WHEN CHARGING

(71) Applicant: AUDI AG, Ingolstadt (DE)

(72) Inventor: Matthias SCHNEIDER, Sappenfeld (DE)

(21) Appl. No.: 18/755,239

(22) Filed: Jun. 26, 2024

(30) Foreign Application Priority Data
Jun. 27, 2023 (DE) 102023116852.5

(51) Int. Cl. B60L 53/66; B60L 53/62

(52) U.S. Cl. CPC B60L 53/665; B60L 53/62

(57) ABSTRACT

A method for carrying out an automatic inspection of a vehicle during a charging process at a charging station is disclosed, wherein a charging process of at least one battery of the vehicle is initiated and measurement data from surfaces of the at least one vehicle is determined by at least one sensor of the charging station, the determined measurement data being evaluated by a local and/or external controller with regard to damage and/or safety deficiencies, and an inspection report being provided in an automated manner during or after a completed charging process of the battery. Furthermore, a vehicle arrangement is disclosed.

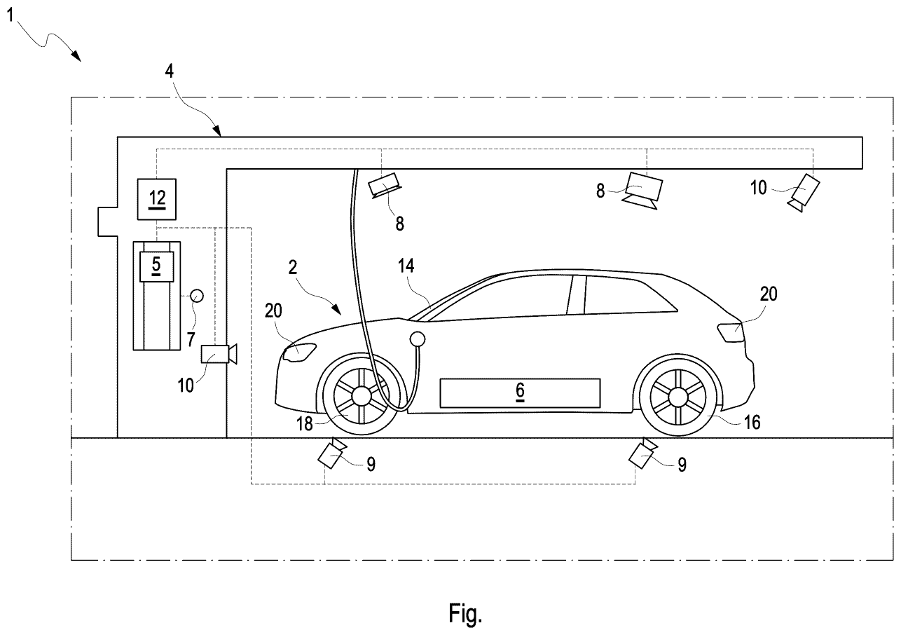

### BACKGROUND

### Technical Field

The disclosure relates to a method for carrying out an automatic inspection of a vehicle during a charging process at a charging station, and a vehicle arrangement with at least one vehicle and with at least one charging station for carrying out said method.

### Description of the Related Art

The operation of vehicles can lead to unintentional damage to the vehicles. For example, damage can be in the form of stone chips, breaks and/or cracks on the panes, in particular the windshield. Furthermore, parking on curbs can be associated with damage to the vehicle's rims and/or tires. If ignored, such damage can lead to dangerous situations on the road.

Typically, vehicles are inspected for damage in annual or biannual inspections. Such inspections are initiated by law or by vehicle manufacturers and can occur too late for many damages. For example, a windshield affected by stone chips can prevent safe travel on a highway after just a few days and pose a safety risk.

### BRIEF SUMMARY

It is the object of the present disclosure to provide a method and a vehicle arrangement through which an automatic inspection of the vehicle is made possible at shorter intervals.

The method according to the disclosure is used to carry out an automatic inspection of a vehicle during a charging process at a charging station. Preferably, the vehicle can be configured as an exclusively electrically driven vehicle or as an electrically drivable vehicle, such as a so-called plug-in hybrid vehicle.

During the charging process, a charging process of at least one battery or traction battery of the vehicle is initiated in a first step. During the charging process, measurement data from surfaces of the at least one vehicle are determined by at least one sensor of the charging station. This determination of measurement data can be carried out in parallel to the charging process, before the charging process or after a completed or aborted charging process.

The measured data determined is then evaluated by a local and/or external control unit for damage and/or safety deficiencies. An inspection report is provided in an automated manner during a charging process of the battery or after a charging process of said battery has been completed.

The method allows the vehicle to be checked for damage in an automated manner. Due to the fact that charging processes occur more frequently than usual inspections, inspections can be provided with greater frequency, which increases road safety. Advantageously, a charging infrastructure, such as, for example, a charging pole and/or a charging station, can have corresponding mechanisms and components by way of which, for example, a windshield or side windows can be examined for possible defects in the glass.

A local and immediate output of an inspection report enables immediate countermeasures to be taken to repair the damage. Such countermeasures can take the form of making an appointment at a workshop, ordering spare parts, immediately replacing damaged components such as lamps or a wheel with a spare wheel, and the like.

According to a further aspect of the disclosure, a vehicle arrangement for carrying out a method according to the disclosure is provided. The vehicle arrangement has at least one charging station and at least one vehicle. The charging station has at least one sensor for determining measurement data from surfaces of the at least one vehicle and at least one control unit for evaluating the measurement data of the at least one sensor. The control unit can be a local control unit that is arranged locally adjacent to the sensors. Alternatively or additionally, the control unit can be configured as an external control unit, for example in the form of a cloud, which can receive the measurement data directly from the sensors or indirectly via a local control unit.

The automatic inspection of the vehicle can be initiated as soon as a user parks their vehicle at the charging pole or initiates the charging process. A scanning device with one or more sensors can be provided to collect the measurement data about the vehicle. Advantageously, several sensors can be arranged spatially offset from one another in order to record the vehicle from different angles.

A user can be a customer, a vehicle driver or a holder of the vehicle or an owner of the vehicle.

Depending on the configuration, at least one movable sensor can be provided. In this case, a movable sensor can be coupled to the charging station, for example by way of an actuator or robot arm, or can be configured to be decoupled from the charging station. A sensor decoupled from the charging station can be arranged, for example, on a drone moving on land or air. This enables a particularly efficient inspection of the vehicle from all sides or angles.

The control unit can be configured in the form of an evaluation unit in order to receive and evaluate the measurement data of the at least one sensor, for example in the form of optical recordings or photos, point clouds and the like. This measurement data can then be analyzed by a processor unit to detect defects and damage. For example, the control unit is a controller that includes a processor and a memory storing instructions that, when executed by the processor, cause the controller to perform the acts of the control unit described herein.

In one exemplary embodiment, the inspection is initiated automatically with the charging process or is set in advance to be carried out automatically with the charging process. The automatic inspection of the vehicle can therefore be implemented in parallel with the charging process. The inspection can be booked in advance by the respective user. The inspection can be booked, for example, via a reservation app for the charging station, via a direct selection at the charging station itself or via another web-based application.

According to a further embodiment, the at least one sensor is configured as a camera sensor, Light Detection and Ranging (LIDAR) sensor and/or radar sensor and is set up to capture at least one surface or surface structure of the vehicle metrologically. This allows sensors to be used to capture metrologically any damage to the vehicle. In particular, measurement data in the form of image recordings and/or in the form of point clouds can be determined by the at least one sensor.

According to a further exemplary embodiment, measurement data from at least one surface of a headlight, taillight, direction indicator, at least one pane of glass, for example a windshield, a side window, a panoramic roof window, a rear window, a body, at least one tire, at least one rim is determined. This measure allows discrepancies or damage to surfaces of the vehicle to be detected using image recognition of the control unit. This means that a visual inspection of the vehicle can be efficiently replaced by a computer-aided image evaluation of the measurement data determined.

According to a further embodiment, based on the measured data determined, at least one damage on at least one surface in the form of a dent, a crack or break, water entry, cloudiness, a stone chip, a foreign body and/or at least one safety deficiency in the form of an insufficient tire tread depth, a tire that is unsuitable for the weather, a damaged rim or tire sidewall or in the form of tire age is determined by the control unit. This measure allows the vehicle to be inspected for a plurality of damages during the charging process. The wheels or tires and rims can be checked for any abnormalities on the tire or rim. In particular, damage to the carcass, cracks or breaks in the rubber, damage to the rim or expired or insufficient tire characteristics, such as DOT stamps or missing M+S markings on the tires in winter, can be captured metrologically and checked.

Furthermore, the windows of the vehicle can be scanned cyclically by at least one sensor, for example in the form of a glass breakage scanner supported by cloud-based image recognition programs, and checked for damage. If damage is detected or damage is suspected, this result can be noted in the inspection report and saved with an associated charging ID.

The at least one sensor, which can also be configured as one or more high-resolution cameras or scanners, can also be used to detect damage to tires and rims. Any abnormalities identified can also be saved under the associated charging ID and mentioned in the inspection report. Furthermore, image and text recognition software in the control unit can check the tire identification number (DOT number) and, if necessary, provide the customer with information about outdated tires or tires that are inappropriate for the weather. The corresponding findings can also be saved using the charging ID and stored in the inspection report. For example, it can be pointed out that the vehicle is traveling in winter temperatures without M+S tires.

The at least one sensor can also be used to collect measurement data that can be used by the control unit to automatically determine damage to headlights and taillights. For example, moisture in the lights, cracks or breaks or scratches in the plastic can be registered by way of sensors. Here, too, if a defect or damage is detected, a corresponding note with the associated charging ID can be noted and described in the inspection report.

Furthermore, the paintwork of the vehicle can also be checked for damage, for example in the form of dents, cracks, deep scratches, rust and the like, and, if necessary, noted in the inspection report.

According to a further exemplary embodiment, the inspection report is provided to a user, for example a driver, owner or manager of the vehicle, locally at the charging station in paper form, by email, using an application on a portable device, via a download link and/or using an onboard output unit. As soon as the scan or the automated inspection and the evaluation of the measurement data determined has been completed, an inspection report can be created via the control unit and made available to the user, for example via the output at the charging station. Depending on how the automated inspection is booked, the inspection report can be provided to the user electronically, displayed via app, sent by email, made available as a download or in paper form as a printed receipt at the charging station. For this purpose, a printer or receipt printer can be provided at the charging station.

According to a further embodiment, at least one service, in particular in the form of a workshop appointment or a spare parts order, is offered to the user and/or initiated based on the determined inspection report. As soon as a defect or damage has been detected via the automated inspection, this information can be made available to the user, for example via an app, a message in the vehicle, a message at the charging pole or charging station and the like. The user can also be offered the option of having the defect or damage repaired by a specialized dealer. This option can be implemented, for example, in the form of an offer to repair the damage or in the form of an automated booking of a service appointment to repair the identified damage at a workshop. Depending on the configuration, the user can also be offered or enabled to order spare parts in order to replace damaged components of the vehicle, such as tires, rims, lamps and the like.

### BRIEF DESCRIPTION OF THE SEVERAL VIEWS OF THE DRAWINGS

The disclosure is shown schematically in the drawings using embodiments and is further described with reference to the drawings.

The FIGURE shows a vehicle arrangement according to an exemplary embodiment according to the disclosure.

### DETAILED DESCRIPTION

The FIGURE shows a vehicle arrangement 1 according to an exemplary embodiment according to the disclosure. Vehicle arrangement 1 has a vehicle 2, which is parked in or at a charging station 4 in order to carry out a charging process for a traction battery 6. The charging infrastructure device or charging station 4 can be used to carry out an automated inspection of vehicles 2. In particular, vehicle arrangement 1 is used to implement a method according to the disclosure for carrying out an automatic inspection of vehicle 2 during a charging process.

A charging station 4 with a vehicle 2 is shown as an example. However, the charging process and the inspection process can be carried out simultaneously on a plurality of vehicles 2 which are parked at several charging stations 4. The inspection process can be initiated or at least authenticated, for example, via an operating display 5 of charging station 4. The inspection of the vehicle 2 can then be carried out in an automated manner.

Vehicle 2 can preferably be configured as an exclusively electrically driven or electrically drivable vehicle 2, such as a so-called plug-in hybrid vehicle, and have a traction battery 6.

The charging station 4 has several sensors 8, 9, 10 for determining measurement data from surfaces of the at least one vehicle 2, and at least one control unit 12 for evaluating the measurement data of sensors 8, 9, 10.

Control unit 12 is configured, for example, as a local control unit which is arranged locally adjacent to sensors 8, 9, 10. Control unit 12 has a storage unit, not shown, for at least temporarily storing measurement data and/or results of evaluations. The results can, for example, be stored and/or output in the form of inspection reports. For this purpose, control unit 12 is set up to receive and evaluate the measurement data of sensors 8, 9, 10.

The automatic inspection of vehicle 2 can be initiated as soon as a user parks their vehicle 2 at charging station 4 or initiates the charging process. During the inspection, vehicle 2 is captured by sensors from different angles.

Several sensors 8 are configured as a scanning system for detecting broken glass or damage to glass surfaces 14. These sensors 8 can be configured as camera sensors. Possible damage to glass surfaces 14 that can be detected can include, for example, stone chips, cracks and/or breaks in the glass panes. The detection is preferably carried out by evaluating the measurement data of sensors 8 by way of control unit 12.

Furthermore, sensors 9 of a camera system are provided with image and text recognition for detecting damage to tires 16 and rims 18. For example, outdated tires 16 can be detected based on a DOT number determined by text recognition with subsequent comparison of the determined DOT number with a database for DOT numbers.

Further sensors 10 can be implemented in charging station 4 in the form of a camera system for detecting defects in headlights and taillights 20.

Respective sensors 8, 9, 10 are advantageously arranged in such a way that vehicle 2 can be captured by sensors from different solid angles and/or heights. Furthermore, sensors 8, 9, 10 are connected to control unit 12 in a data-conducting manner. This allows control unit 12 to receive and evaluate the determined measurement data.

Control unit 12 can be equipped locally or with a cloud connection to control the inspection and evaluate the measurement data received. Control unit 12 can carry out text recognition, image recognition, a comparison with target geometries and the like in order to determine damage and/or discrepancies on vehicle 2.

After the inspection has been carried out, an inspection report can be provided locally, for example with the help of a receipt printer 7.

German patent application no. 102023116852.5, filed Jun. 27, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for carrying out an automatic inspection of a vehicle during charging at a charging station, the method comprising:
initiating a charging process of a battery of the vehicle;
determining measurement data from surfaces of the vehicle by at least one sensor of the charging station;
evaluating the measurement data by a controller with regard to damage and/or safety deficiencies; and
providing an inspection report in an automated manner during the charging process of the battery or after the charging process of the battery has been completed.

2. The method according to claim 1, wherein an inspection of the vehicle is initiated automatically with the charging process or is set in advance to be carried out automatically with the charging process.

3. The method according to claim 1, wherein the at least one sensor is configured as a camera sensor, Light Detection and Ranging (LIDAR) sensor and/or radar sensor and is set up to capture at least one surface or surface structure of the vehicle metrologically.

4. The method according to claim 1, wherein the measurement data is determined from at least one surface of a headlight, taillight, direction indicator, at least one pane of glass, a body, at least one tire, or at least one rim.

5. The method according to claim 1, further comprising:
determining, by the controller, based on the measurement data, damage on at least one surface including a dent, a crack or break, water entry, cloudiness, a stone chip, a foreign body and/or at least one safety deficiency including an insufficient tire tread depth, a tire that is unsuitable for current weather, a damaged rim or tire sidewall or a tire age.

6. The method according to claim 1, wherein the providing includes providing the inspection report to a user, a driver, owner or manager of the vehicle, locally at the charging station in paper form, by email, using an application on a portable device, via a download link and/or using an onboard output unit.

7. The method according to claim 1, further comprising:
offering or initiating, based on the inspection report, a workshop appointment or a spare parts order.

8. A vehicle arrangement comprising:
a charging station that, in operation, initiates a charging process of a battery of a vehicle;
wherein the charging station includes at least one sensor that, in operation, determines measurement data from surfaces of the vehicle; and
a controller including a processor and a memory storing instructions that, when executed by the processor, cause the controller to:
evaluate measurement data of the at least one sensor with regard to damage and/or safety deficiencies,
provide an inspection report in an automated manner during the charging process of the battery or after the charging process of the battery has been completed.
